(19) United States
(12) Patent Application Publication
(10) Pub. No.: US 2007/0129653 A1
(43) Pub. Date: Jun. 7, 2007

(54) Spring-over-muscle actuator

(75) Inventors: Thomas Sugar, Tempe, AZ (US); Michael R. Carhart, Phoenix, AZ (US)

Correspondence Address: CONNOLLY BOVE LODGE & HUTZ LLP, P.O. BOX 2207, WILMINGTON, DE, 19899-2207, US

(73) Assignee: THOMAS SUGAR, TEMPE, AZ (US)

(21) Appl. No.: 10/554,415

(22) PCT Filed: Apr. 26, 2004
(86) PCT No.: PCT/US04/13117

§ 371 Date: Oct. 24, 2005

Related U.S. Application Data
(60) Provisional application No. 60/465,315, filed on Apr. 24, 2003.

(51) Int. Cl. A61H 1/02

(52) U.S. Cl. 601/5; 601/148; 601/23; 601/33

(57) ABSTRACT

Pneumatic muscles capable of delivering bi-directional forces are described having an actuator with a tube or bladder surrounded by a braided material mounted in parallel with a resilient spring. When the bladder is pressurized with a pneumatic source, it expands, and its length contracts. During the contraction cycle, the resilient spring is compressed and stores energy until subsequently released, which corresponds when the pressure in the bladder is released. As the spring expands, it produces an expansion force. The contraction and expansion forces are controllable using a number of configurations, including changing the equilibrium position of the resilient spring, using a different rated bladder, and using different initial pressure.

Pneumatic muscle actuators are generally discussed herein with specific discussions extended to pneumatic muscle actuators having a bladder or tube mounted in parallel with a resilient spring to generate pulling and pushing forces.

### BACKGROUND

A conventional pneumatic muscle actuator generally comprises an internal bladder or tube surrounded by a braided mesh and attached at each end to a mechanical fitting, such as a header comprising female threads, a hook, a coupling male threads, etc. Exemplary prior art pneumatic muscle actuators include those manufactured by Festo Corporation, the Shadow Robot Company, Kinetic Muscles Inc., and other manufacturers of the McKibben type actuators. When pressurized by a pneumatic source, the internal bladder or tube expands against the interior surface of the braided mesh, which constrains the overall bladder expansion causing the braid to shorten. Concurrently, as the bladder expands, the braid length contracts or decreases, thus producing a contraction force.

Pneumatic muscle actuators, commonly referred to as pneumatic artificial muscles or PAMs, are widely used in factory floor automation, robotics, medical industries, and numerous other applications. The pulling force or bladder contraction when pressurized coupled with the fittings at the bladder's two ends allows the PAM to produce an action, reaction, or work, such as toggling a switch or lifting a payload. As a typical PAM only generates a unidirectional force when pressurized by a pneumatic source, two PAMs are generally necessary when a bi-directional force is required. With two PAMs, the number of supporting devices to operate the PAMs, such as controllers, electronics, and a larger compressed pneumatic source, also increase. In a typical installation, the two PAMs are generally mounted in an antagonistic configuration to create a push and a pull.

While using multiple PAMs in an application is a viable option, space or size of a particular application, funding and other constraints may make their use impracticable. Accordingly, there is a need for a pneumatic muscle actuator adapted to impart a bi-directional force without significant added equipment.

### SUMMARY

The present invention may be implemented by providing a muscle actuator comprising an inner bladder comprising a first end and a second end and the inner bladder being configured to communicate with a pneumatic source, a braided material wrapped over at least a substantial portion of the inner bladder, an end fitting attached to both the first end and the second end, and a helical coil spring positioned over at least a portion of the braided material or inside the inner bladder.

In another aspect of the present invention, there is provided a muscle actuator comprising an inner bladder comprising a first end and a second end and the inner bladder being configured to communicate with a pneumatic source, a braided material wrapped over at least a substantial portion of the inner bladder, an end fitting attached to both the first end and the second end, and a mechanical device capable of receiving a compression force and generating a pushing force when the compression force is removed mounted in parallel with the muscle actuator.

In still yet another aspect of the present invention, there is provided a combination pneumatic actuator muscle and a mechanical device capable of receiving a compression force and generating a pushing force when the compression force is removed mounted to a first surface and a second surface, wherein a passage is incorporated in a header of the pneumatic actuator muscle for receiving a pressurized source, wherein the pneumatic actuator muscle produces a pulling force to compress the mechanical device when the pressurized source enters the pneumatic actuator muscle; and wherein the mechanical device generates a pushing force when the pressurized source is discharged from the pneumatic actuator muscle.

### BRIEF DESCRIPTION OF THE DRAWINGS

These and other features and advantages of the present invention will become appreciated as the same become better understood with reference to the specification, claims and appended drawings wherein:

FIG. 1 is a semi-schematic partial cross-sectional side view of a spring over muscle provided in accordance with aspects of the present invention comprising a spring mounted in parallel with an expandable bladder-type pneumatic muscle;

FIG. 2 is a semi-schematic partial cross-sectional side view of an alternative spring over muscle provided in accordance with aspects of the present invention also comprising a spring mounted in parallel with an expandable bladder-type pneumatic muscle;

FIG. 3 is a semi-schematic partial cross-sectional side view of a spring housing component for use with an expandable bladder-type pneumatic muscle;

FIG. 4 is a semi-schematic side view of a spring over muscle comprising an expandable bladder-type pneumatic muscle mounted over the spring housing component of FIG. 3;

FIG. 5 is a semi-schematic side view of a lower extremity robotic assist device comprising a hinged knee brace and a plurality of spring over muscle actuators;

FIG. 6 is a frontal view of the robotic assist device of FIG. 5;

FIG. 7 is a semi-schematic view of an alternative spring over muscle provided in accordance with aspects of the present invention comprising a spring mounted in parallel inside a pneumatic actuator muscle;

FIG. 8 is a semi-schematic view of another alternative spring over muscle provided in accordance with aspects of the present invention utilizing a shock absorber mounted in parallel with a pneumatic actuator muscle;

FIG. 9 is a semi-schematic view of yet another alternative spring over muscle provided in accordance with aspects of the present invention comprising a spring mounted over a pneumatic actuator muscle;

FIG. 10 is a semi-schematic view of still yet another alternative spring over muscle provided in accordance with aspects of the present invention comprising a spring having an adjustable clamp mounted over a pneumatic actuator muscle;

FIG. 11 is a semi-schematic view of still yet another alternative spring over muscle provided in accordance with aspects of the present invention in which a pneumatic actuator muscle and two springs are mounted to two clamps;

FIG. 12 is a semi-schematic view yet another alternative spring over muscle provided in accordance with aspects of the present invention in which a pneumatic actuator muscle and a spring are mounted to a lever arm for providing a pushing force and a pulling force on the lever arm;

FIG. 13 is a semi-schematic view of a six degree of freedom robotic arm using twelve conventional pneumatic actuator muscles.

### DETAILED DESCRIPTION

The detailed description set forth below in connection with the appended drawings is intended as a description of the presently preferred embodiments of a spring over muscle actuator provided in accordance with practice of the present invention and is not intended to represent the only forms in which the present invention may be constructed or utilized. The description sets forth the features and the steps for constructing and using the spring-over muscle actuator of the present invention in connection with the illustrated embodiments. It is to be understood, however, that the same or equivalent functions and structures may be accomplished by different embodiments that are also intended to be encompassed within the spirit and scope of the invention. Also, as denoted elsewhere herein, like element numbers are intended to indicate like or similar elements or features.

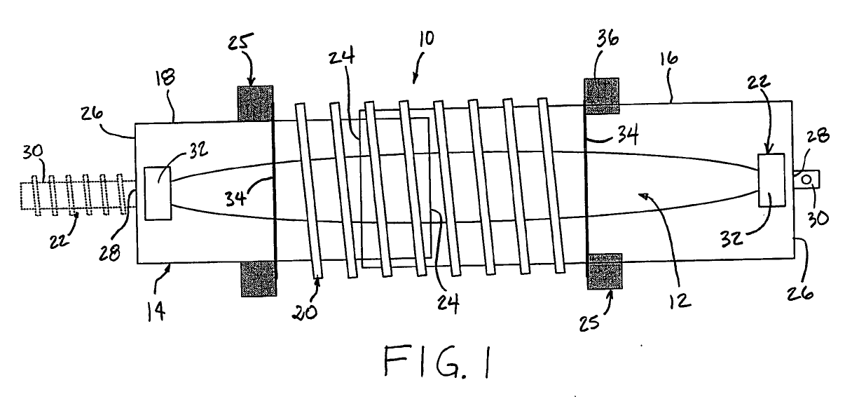

Referring now to FIG. 1, there is shown a semi-schematic partial cross-sectional side view of a spring over muscle (herein “SOM”) provided in accordance with aspects of the present invention, which is generally designated 10. In an exemplary embodiment, the SOM 10 incorporates a prior art pneumatic muscle actuator 12 comprising an expandable-type bladder surrounded by a braided material, which may be similar to any number of actuators made by Festo Corporation, the Shadow Robot Company, and other manufacturers of the McKibben type actuators or their equivalents. The SOM 10 also incorporates an actuating cylinder 14 comprising a first telescoping cylinder section 16 and a second telescoping cylinder section 18, a resilient spring 20, and a plurality of mechanical connectors 22, 30. As further discussed below, the mechanical connectors 22, 30 permit adjustment to be made to the spring equilibrium position and to connect the SOM 10 to external devices or structures. The spring's equilibrium position can comprise stretching or putting the spring in tension or shortening the spring in compression.

In an exemplary embodiment, the first and second cylinder sections 16, 18 of the actuating cylinder 14 may be made from a plastic, metal or material such as acrylic, delrin or aluminum. The material and the gauge or thickness of the cylinder sections 16, 18 should be selected to withstand the expected tensile and compressive forces generated by the pneumatic actuator 12 and the spring 20, as further discussed below.

Each cylinder section includes an open first end 24 and a closed second end 26 comprising an access opening 28 for terminating the mechanical connector 22. While the second cylinder section 18 is shown projecting into the first open end 24 of the first cylinder section 16, the actuating cylinder 14 may have a reverse configuration wherein the first cylinder section projects into the open first end 24 of the second cylinder section 18. The two cylinder sections 16, 18 may have a number of different cross-section configurations including a square, an elliptical, or a circular cross-section, with the circular cross-section being more preferred.

The mechanical connectors 22 on the two ends of the pneumatic actuator 12 are standard connectors in the related field of art and include header sections 28 and necessary fittings 30 for connecting the actuator 12 in a desired application. In an exemplary embodiment, the header sections 28 include two female threads for connecting with two mechanical fittings 30, which may range from a hook, a male stud, a compression fitting, a socket-type fitting, or any known mechanical fittings. However, at least one of the header sections 28 or one of the fittings 30 or both must include a passage for fluid communication between the interior of the bladder of the pneumatic actuator 12 and an air source (not shown). The passage may extend radially, axially, or a combination of both in the header section 28 or in the fitting 30, as is well known in the related art. As readily apparent the two end fittings 30 extend outwardly away from the second ends 26 of the two telescoping sections 16, 18 and may be used to attach the SOM 10 to a structure, a platform, or any number of devices for acting on by the SOM 10, as further discussed below.

The mechanical connectors 25 on the two ends of the spring 20 are means for adjusting the spring position relative to the actuating cylinder 14, and hence the equilibrium position of the spring. The mechanical connectors 25 may comprise hose clamps, a combination ring or disc or straps 34 with one or more gaps for adjusting (i.e., tightening) using a variable threaded device 36, such as a combination nuts and bolts or bolts and wing nuts. Alternatively, the mechanical connectors 25 may incorporate a simple motor device to actively control the spring position. In use, one or both sets of mechanical connectors 25 may be moved and re-positioned on the two telescoping sections 16, 18 to pre-load (i.e., compress or expand) the spring 20. This pre-loading changes the equilibrium position of the spring 20 and hence the force-deflection curve of the overall SOM 10 to thereby produce a different SOM 10 output for different applications, as further discussed below.

As previously discussed, current pneumatic muscle actuators exert a contractile force when pressurized. Thus, the prior art pneumatic muscle actuators will only produce a unidirectional force that cannot push against a surface. In the present exemplary embodiment, the SOM 10 utilizes a compression or tension spring 20 in-parallel with the pneumatic muscle 12 to overcome the prior art shortcomings and provide a second directional force. In the presently preferred embodiment, the spring 20 resists compressive forces while the pneumatic muscle 12, when pressurized, resists tensile forces. The extent to which the spring 20 resists compressive forces is dependent on its stiffness while the pneumatic muscle's resistance to tensile forces depends on the property of the rubber bladder and the braid.

The SOM 10 of the presently preferred embodiment is capable of generating forces in tension and compression. The pulling force is generated when the muscle actuator 12 is pressurized. As is well known in the art, when the actuator 12 is pressurized, it contracts in length and produces a pulling force. Since the two telescoping sections 16, 18 are attached to the actuator 12, they will telescopically contract, and since the spring 20 is attached to the two telescoping sections 16, 18, it too contracts or compresses. As the passive spring 20 is compressed, energy is stored that can later be released to apply a desired pushing force. The actuator length and tensile/compressive force output may be controlled by adjusting the input pressure to the pneumatic muscle 12 and the equilibrium position of the spring 20. This approach simplifies control, and requires fewer load sensors, electronic controls, and parts for a comparable system using prior art pneumatic muscle actuators.

As a comparison between a prior art unidirectional pneumatic muscle actuator and a bidirectional muscle actuator of the presently preferred embodiment, a force deflection curve for a typical prior art pneumatic muscle is obtained (Kinetic Muscles, Inc.) (See Chart 1 below). The muscle consisted of a ½ inch rubber tube with a 1 and ¼ inch braid surrounding the tube. The experiment conducted to gather the data for the Chart 1 includes supplying pressure to the bladder to activate the pneumatic muscle, which causes the bladder to expand against the braid resulting in a compressive force. If the pneumatic muscle is mounted by hanging a first end such that the lengthwise direction of the bladder is vertical, for a given input pressure, an upward force is produced at the lower second end of the bladder. Different weights were then hung downward from the second end of the pneumatic muscle to determine the deflection caused by different loads in static equilibrium. As shown in the Chart 1 graph, the lower pressures result in a flatter force deflection curve with large deflections and elongation up to about 30%. With higher pressures, the force deflection curve is steeper and the amount of elongation is only about 18%. The original length of the actuator was approximately 20 to 23 cm.

[image]

In the new SOM 10 actuator provided in accordance with aspects of the present invention, a compression spring 20 is added in parallel to the pneumatic muscle 12. The spring constant must first be chosen. However, the equilibrium position of the spring 20 can be altered (i.e., by sliding one or both of the mechanical connectors 25 to the left or right of the position shown in FIG. 1) to adjust the SOM's force-deflection curve. Note, the spring's intrinsic value cannot be changed but the stiffness of the actuator can be changed by changing the equilibrium position of the spring on the actuating cylinder 14. The combined force deflection curve of the standard spring and the pneumatic actuator are added to define a new curve capable of applying bilateral forces (pushing and pulling on the environment). Alternatively, different spring constants can be chosen to alter the output force of the SOM actuator 10.

In a test of the SOM actuator 10 of the presently preferred embodiment, the compressive spring 20 has a stiffness of 119 N/cm and the equilibrium position varies between 0 and 25 mm. As the pneumatic muscle actuator 12 is shortened by increasing the air pressure, the spring 20 is compressed and stores energy. When the pressure in the pneumatic muscle 12 is then controllably released using flow control valves, servo-valves, etc., the spring uncoils and pushes against the environment. Also, if an external force pushes against the actuator, the spring will resist the compressive force.

In practice, the home position (i.e., Force=0 N) of the SOM actuator 10 provided in accordance with the presently preferred embodiment should be established given a particular operating pressure. That is, the pneumatic actuator should be pressurized to exert a contraction force against the spring to store energy that can be released to push against the environment, or against some object, such as a toggle switch, a plate, an arm, etc. In one example, if the pneumatic muscle 12 is pressurized to 20 psi then the SOM actuator 10 contracts 12.5 mm. If an external force pulls on the SOM actuator 10, the pneumatic muscle 12 resists the force and lengthens. In a similar analogy, if an external force pushes on the SOM actuator 10, the spring 20 resists the compressive force and the actuator shortens.

A force deflection curve for the SOM actuator 10 obtained by adding a standard compression spring 20 to the prior art pneumatic muscle 12 is shown in Table 2 below. As is evident by the table, when F=0 N is chosen for the home position, that is, when the bladder in the pneumatic muscle is pressurized to exert a contraction force against the spring, the original force-deflection curve of the prior art bladder (i.e., Table 1) can be shifted.

[image]

As readily recognized, the particular force deflection curve shown in Table 2 is exemplary only and that other curves having different force versus displacement characteristics may be produced by selecting a different pneumatic muscle, a different spring constant, or by adjusting the equilibrium position of the selected spring.

Turning now to FIG. 2, there is shown a semi-schematic partial cross-sectional side view of an alternative spring over muscle 38 provided in accordance with aspects with the present invention. The SOM 38 of the present embodiment is capable of producing a bidirectional force. In an exemplary embodiment, the SOM 38 comprises an actuating cylinder housing 40 comprising an outer telescoping housing section 42 and two internal telescoping housing sections 44, 46, a prior art pneumatic muscle actuator 12, and a spring 20. The alternative SOM 38 operates in the same manner as the SOM 10 of FIG. 1 to produce a bidirectional force, as further discussed below.

In an exemplary embodiment, the first internal telescoping section 44 is secured or fixed to the outer telescoping section 42, such as by threads or by detent engagement or can slide on sections 44 and 46. The telescoping section 42 is used to prevent buckling of the spring 20. Other methods can be used as well to prevent buckling such as using a rod with guides. A mechanical connector 30 is then used to secure the first end 48 of the pneumatic muscle 12 to the first internal telescoping section 44, via an opening 50 on the closed end 51 and one or more nuts or wing nuts (not shown). The end section 52 of the open end 53 of the internal section 44 then acts as a shoulder for one of the spring ends. Alternatively, instead of incorporating the first internal telescoping section 44, the shoulder may be molded, formed, or machined into the internal surface of the outer telescoping section 42. In an exemplary embodiment, the first internal telescoping section 44 may be moved telescopically relative to the outer housing section 42 to change the equilibrium position of the spring 20 and/or to change the length configuration of the SOM for different applications. Conventional attachments means such as detents, sockets, threads, and the like may be used to alter or adjust the first telescoping section 44 relative to the outer housing section 42.

The second internal telescoping section 46 is a movable internal telescoping housing section, which has an open end 56 and a closed end 58 comprising an opening 60. The second internal section 46 is capable of moving relative to the outer telescoping housing section 42 when pushed or pulled. The second end 62 of the pneumatic muscle 12 is attached to the closed end 58 of the second internal housing section 46 by using one or more nuts or wing nuts (not shown) to fasten the threaded shaft 31 to the closed end 58. As readily apparent, the nuts' position (not shown) may vary along the length of the threaded shaft, to vary the equilibrium position of the spring 20, for reasons discussed above.

A passage (not shown) for the pneumatic source may be located at either the first end 48 or the second end 62 of the pneumatic muscle 12. The passage may include an axial component, a radial component, or a combination of both. For accessing the passage, a slot or notch on the actuating cylinder housing 40 may be incorporated. For further general information regarding the passage and various fittings incorporating the passage or useable with the passage, reference is made to Festo Corporation product catalog, Fluidic Muscle MAS, Info 501, its contents are expressly incorporated herein by reference.

In use, pressure is supplied to the bladder of the pneumatic muscle 12, which then causes the muscle to contract. As the muscle contracts, it pulls the second internal telescoping housing section 46 towards the first internal cylinder 44, which then compresses the spring 20. Thus, the two open ends 52, 56 of the two internal sections 44, 46 must be spaced sufficiently to permit contraction. Furthermore, the spring 20 and the internal bore of the housing 42 should be selected so as to provide sufficient expansion space for the bladder. As previously discussed, when the pressure in the bladder is subsequently released, the spring 20 expands to provide a second force.

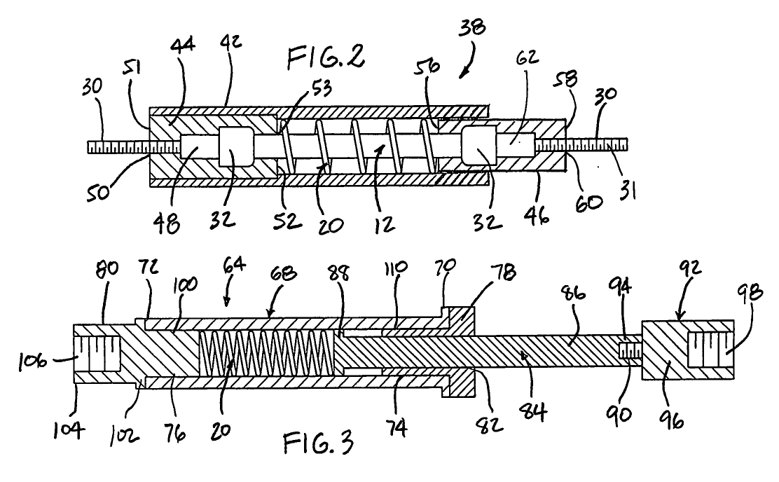

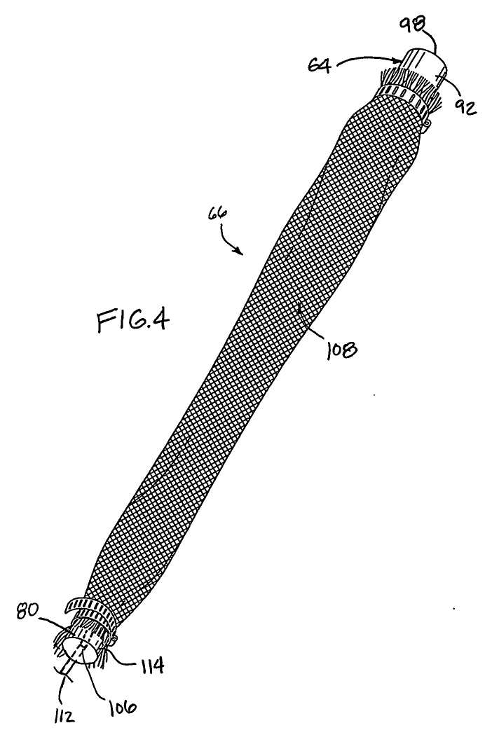

Referring now to FIG. 3, there is shown a spring housing component 64 of another alternative spring over muscle 66 (FIG. 4) provided in accordance with aspects of the present invention. In the presently preferred embodiment, the spring 20 is mounted within a spring housing 68, which is then mounted internally of a prior art pneumatic muscle, as further discussed below. Like the SOMs described above, the spring housing component 64 may be fabricated from a number of materials including delrin, fiberglass reinforced ABS, metal, aluminum, and carbon fiber, just to name a few.

In an exemplary embodiment, the spring housing 68 comprises an elongated housing comprising two flanged ends 70, 72. In one exemplary embodiment, female threads 74, 76 are incorporated in the flanged ends 70, 72 for threaded engagement with two end fittings 78, 80. Alternatively, detents or fasteners may be incorporated to fasten the end fittings 78, 80 to the flanged ends 70, 72. The first end fitting 78 resembles a bushing and comprises a passage 82 for receiving a piston rod 84. The piston rod 84 comprises a shaft 86 and a flared end 88 comprising an enlarged base for supporting one end of the spring 20. The flared end 88 may be an integrally formed or a machined shoulder sized to support one end of the spring 20. The shaft 86 is adapted to slide within the passage 82 of the first end fitting 78 to compress the spring 20, as further discussed below. At the opposite end of the flared end 88 is a terminal end 90 comprising a threaded bore for threaded engagement with a bull plug 92. In an exemplary embodiment, the bull plug 92 comprises a threaded stem 94 for threaded engagement with the female threads in the terminal end 90 of the shaft 86 and an enlarged header 96 comprising female threads 98. Other fittings may then be used to fasten to the female threads 98.

The second end fitting 80 comprises a threaded stem 100, a shoulder or flange 102, and a header 104 comprising female threads 106. The threaded stem 100 is adapted to threadedly engage with the female threads 76 on the flanged end 72 and support one end of the spring 20. Accordingly, the threaded stem 100 should have a cross-sectional dimension sufficient to support the spring.

The piston rod 84 of the spring housing component 64 is adapted to slide bi-directionally within the passage 82 of the first end fitting 78. This bi-directional sliding motion is generated when the shaft 86 is acted on, either directly or indirectly, by a pneumatic muscle 108 (FIG. 4) and by the spring 20. More particularly, when the pneumatic muscle is pressurized, it contracts, as discussed above. If the muscle is attached to the bull plug 92, which is connected to the shaft 86, it pulls on the bull plug 92, which then moves the shaft in a first direction towards the second end fitting 80. As the shaft moves in the first direction, the flared end 88 compresses the spring 20. When the pressure is subsequently released from the pneumatic muscle, the spring 20 releases and expands, pushing the flared end 88 towards the second direction, away from the second end fitting 80.

In one exemplary embodiment, means for changing the spring's equilibrium position is incorporated in the spring housing component 64 (not shown). The means for adjusting the spring's position may include a spacer, a sleeve, or a plurality of washers for altering the length of the shaft 86. The equilibrium position may also be adjusted by changing the length of the male stems 100, 110 of the two end fittings 78, 80, or changing the length of the spring 20. Other means for changing the spring's equilibrium position may be practiced without deviating from the spirit and scope of the present invention. Furthermore, while the bull plug 92 and the second end fitting 80 are shown with female threads for connecting to other mechanical devices, such as to an eye bolt or to a hook bolt, other mechanical terminal ends may be used, including a flanged end, a socket, a snap fitting, etc.

Referring now to FIG. 4, the alternative SOM 66 comprises a McKibben style pneumatic muscle 108 mounted over the spring housing component 64 of FIG. 3 and attached at both ends to the second end fitting 80 and the bull plug 92. In an exemplary embodiment, an inlet air valve 112 positioned on a side of the header 114 is selected so that the female threads 98, 106 on the end fitting 80 and to the bull plug 92 are accessible for subsequent attachments to other components. As readily recognized, in the present SOM 66 configuration, the spring housing component 64 (FIG. 3) is mounted inside the bladder (not shown) of the pneumatic muscle 108, which is then surrounded by a braided material, as is well known in the art. Because the spring housing component 64 does not incorporate any sealed cavity, the pressure that it will experience when the pneumatic muscle 108 is pressurized should not pose any structural issues. The pneumatic muscle 108 is clamped on the spring housing 68 and the plug 92. Clamping methods could include but are not limited to hose clamps, compression fittings, gluing, molding with plastic, casting etc.

Referring now to FIG. 5, there is shown a semi-schematic side view of a lower extremity robotic assist device 114 comprising a hinged knee brace 116, a foot support 118, and two spring over muscles 120 provided in accordance with aspects of the present invention. The robotic assist device 114 is adapted to effect ankle in/eversion and dorsilplantarflexion to facilitate rehabilitation of ankle spastic inversion and plantarflexion, which is a significant problem in hemiplegics following a stroke.

In one exemplary embodiment, the knee brace 116 comprises an upper brace frame 122 connected to a lower brace frame 124 via a hinge 126 comprising a torsional spring. A plurality of elastic straps 128 are used to strap the knee brace 116 to a subject 130 to be rehabilitated. The knee brace 116 may be constructed from a number of thermoplastic material, wrapped or padded steel frame, etc., which are well known in the art with the exception of various attachment points further discussed below.

In an exemplary embodiment, a pair of hooks 130, one located at approximately the mid section of the upper brace frame 132 and another at approximately the medial section of the mid-brace frame 134 of the lower brace frame 124, are incorporated. A conventional prior art pneumatic muscle 136 is attached to the two hooks 130 to effect tension on the knee joint when pressurized, as further discussed below. Two additional hooks 130 are incorporated on the lower brace frame 124 preferably also at the mid-brace section 134 to function as attachment points for the two SOMs 120.

The foot support 118 incorporated may be a rigid plate comprising two sides 138 with each side comprising a hook 130 to function as an attachment point for the SOM 120. The foot support 118 should be sized to accommodate a foot, a shoe, or both and may be made from a hard thermoplastic or from a metal. A heel section (not shown) may be added to the foot support 118, either as an integral unit or through a mechanical connector, to support the heel.

Although not shown, peripheral devices such as a pressurized air source, a controller for regulating air input to and air discharge from the pneumatic muscles of the two SOMs 120, are necessary to operate the robotic assist device 114. The controller may also be used to sequentially control the input and output of pressurized air to and from the pneumatic muscles to generate different tension and compression cycles to produce eversion, inversion, dorsiflexion, and plantarflexion motions on the ankle. In other words, synchronized or independent motion from each of the SOM 120 can be used to achieve a complex array of angle movements that include dorsiflexion, plantarflexion as well as inversion and eversion. For example, if both SOMs 120 lengthen in unison, the ankle rotates counterclockwise in planterflexion. If both SOMs 120 shorten in unison, the ankle rotates clockwise in dorsiflexion. If one of the SOMs shortens and the other lengthens, then the ankle is inverted or everted.

Referring now to FIG. 6, a frontal view of the robotic assist device 114 is shown. The two SOMs 120 are attached to the front of the shank exoskeleton of the subject 130: one medially, and one laterally. The SOM actuator attached medially 140 will connect to the medial side of the foot support 138 affixed to the foot, while the SOM attached laterally 142 will connect to the foot support 138 in the area adjacent to the lateral forefoot. Adjuster screws (not shown) may be used to facilitate device adjustment for subjects with differing lower limb length. Other attachment points are considered to be within the spirit and scope of the present invention. For example, the actuators could cross over each other for stability connecting on the opposite side.

In the configuration shown, the robotic assist device 114 resembles an ankle tripod mechanism. In other words, the medial and lateral actuators 140, 142 form the active links of the tripod, while the bones of the shank (tibia and fibula, illustrated by the dotted line 144) form a passive link. Mechanical linkages may be incorporated between the two SOMs 120 to limit length asymmetries, and thereby ensure that the device does not exceed ankle in/eversion range of motion. In additional, mechanical stops may be incorporated to limit minimum and maximum lengths of the SOMs 120 to ensure that dorsi/plantarflexion ankle SOM is not exceeded.

A tripod mechanism/constraint with one single fixed link (i.e., the shank) offers a number of significant advantages. First, it has two degrees of freedom which can accommodate the hinge like motion of the foot with respect to the tibia which occurs at the tibiotalor (dorsiflexion/plantarflexion) and subtalar joints (inversionleversion). Secondly, it is a stable mechanism, compatible with ankle stabilization. Third, additional mechanical linkages can be incorporated into the design to limit the minimum and maximum lengths of the active tripod links (limiting dorsiflexion/plantarflexion), as well as the asymmetry in these lengths (lifting inversion/eversion). Although parallel mechanisms have a smaller workspace than comparable serial mechanisms, this is not a disadvantage in the present embodiment as ankle motion should be limited for safety. In comparison, two conventional pneumatic muscles can be mounted antagonistically in front of and in back of the lower leg to dorsiflex or plantarflex the ankle. It would take an additional pair of pneumatic muscles to be mounted on the side of the leg to invert and evert the ankle.

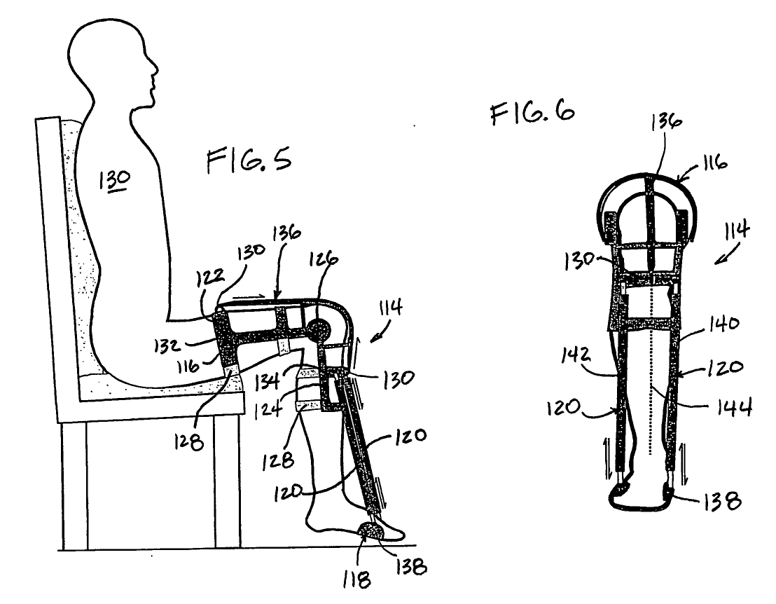

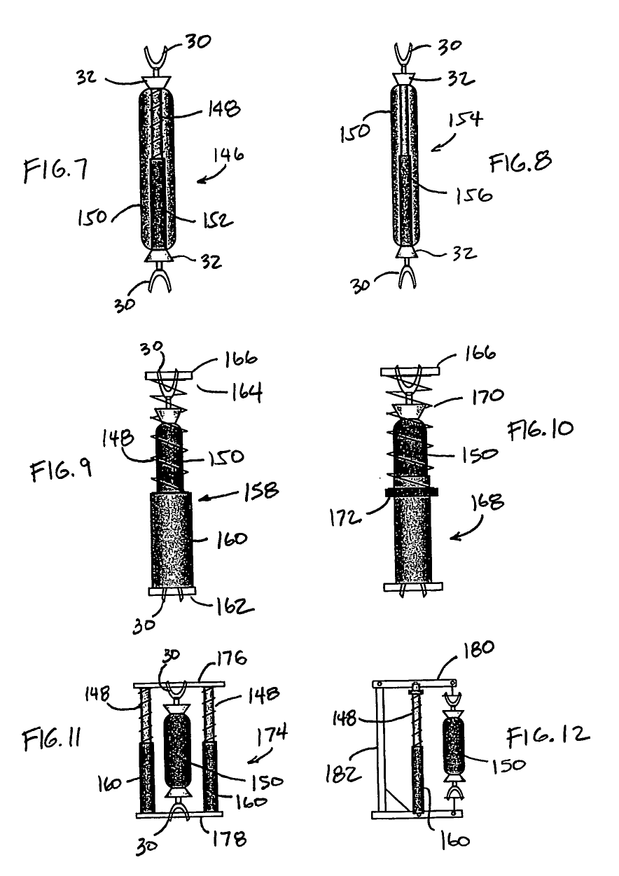

Referring now to FIG. 7, a semi-schematic partial transparent side view of an alternative SOM 146 provided in accordance with aspects of the present invention is shown. In one exemplary embodiment, the SOM 146 comprises a resilient spring 148 positioned inside a conventional PAM 150. The spring 148 may comprise a part of an internal component that includes an elongated tube 152 for receiving the spring. Two mechanical connectors 30 are shown at the outlet ends of the PAM 150 for mechanical coupling to a structure or devices. The connectors 30 can incorporate any prior art connectors, as previously discussed. For changing the equilibrium of the spring 148, means are provided at one and/or both ends of the PAM 150. The adjustment means may include a threaded device, a socket-type device, and a simple motor control device using gears and the like.

As with previously described SOMs and as with other SOMs described elsewhere herein, an air passage (not shown) is provided at one of the ends of the PAM 150 to permit input of a pressurized source to the bladder. Furthermore, a flow control valve or a servo-valve may be used with the same passage or a second passage at an opposite end of the first passage to control the release of the pressure source from the bladder.

In extension, the muscle 150 of the alternative SOM 146 resists the tensile forces pulling on the environment. In compression, such as when a pressurized source is introduced, the inflated muscle 150 and the compression spring 148 resist the compressive forces pushing on the environment. The components inside the muscle reduce the amount of air required by the PAM 150 to inflate the bladder as the components take a large part of the original volume. This in turn allows for a very compact SOM configuration.

Referring now to FIG. 8, an alternative spring over muscle 154 provided in accordance with aspects of the present invention is shown comprising a shock absorber 156 positioned inside a conventional PAM 150. As is readily apparent to a person of ordinary skill in the art, when the PAM is pressurized, it compresses the shock absorber 156, which then extends out when the compressive force is removed or reduced. Exemplary shock absorbers usable with the present invention include compression gas spring-type shock absorbers. For an embodiment in which the equilibrium position of the shock absorber 156 may be adjusted, a locking gas spring-type shock absorber may be used. Locking gas spring shock absorbers operate like a normal compression gas spring but have the capability of being lockable against compression and extension movement in any position along its stroke. The locking ability is controlled by the plunger located on the end of the rod which operates a valve on the piston. When locked, the spring is able to support a much higher compression and extension loads. In one exemplary embodiment, a semi-rigid locking gas spring shock absorber is used, which has a piston that always locks and travels in a fluid medium. As is readily apparent to a person of ordinary skill in the art, the locking mechanism for the locking gas spring shock absorber should be positioned outside the PAM 150 to permit adjustment to the shock absorber.

Referring now to FIG. 9, yet another alternative SOM 158 provided in accordance with aspects of the present invention is shown. The alternative SOM 158 comprises a spring positioned externally of the PAM 150. In an exemplary embodiment, an elongated housing 160 is secured to a first end 162 of the PAM 150 such that the housing 160 cannot move relative to the point of attachment at the first end. The spring 148 is then placed in abutting relationship with the elongated housing 160 at the first end and has a free end 164 extending in the opposite direction. The free end 164 comprises a disc or plate 164 comprising an opening for the mechanical connector 30 to pass through.

In use, the connectors 30 are connected to a structure or a device with the disc or plate 164 on the free end 164 of the spring 148 abutting the same structure or device. When the PAM 150 is pressurized and the pressure later released, the spring 148, which is fixed to the SOM near the first end 162 of the muscle, will push against the same structure to generate a pushing force.

FIG. 10 shows a modified version of the SOM of FIG. 9. In the modified SOM 168 embodiment, the spring 170 is mounted externally of the elongated housing 160 and is equipped with an adjustable clamp 172. The adjustable clamp 172 may be repositioned at various positions on the elongated housing 160 to thereby change the equilibrium position of the spring 170.

Referring now to FIG. 11, a modified spring over muscle 174 comprising a plurality of springs 148 mounted in parallel with a PAM 150 is shown. In an exemplary embodiment, two springs 148 in two elongated housings 160 are mounted to two flanges or platforms 176, 178. A PAM 150 is positioned in between the two springs 148 and also mounted to the same two flanges 176, 178. The two flanges may then be mounted to a structure or a device to be acted on by the spring over muscle 174.

In an alternative embodiment (not shown), the spring 170 and adjustment clamp 172 combination of FIG. 10 is used with the PAM 150 of FIG. 11. This combination allows the equilibrium position of the spring 170 to be adjusted to change the force-deflection curve of the overall actuator 174.

In still yet another alternative embodiment, a PAM 150 is connected in parallel with a spring 148 and elongated housing 160 and the two connected to a moveable lever arm 180. The lever arm 180 is, in turn, connected to a supporting structure 182. In practice, the lever arm 180 and structure 182 may resemble any hinged type devices, such as a switch, a payload on a pulley, a robot arm, a brace, etc.

In an alternative embodiment (not shown), the spring 170 and adjustment clamp 172 combination of FIG. 10 is used with the PAM 150 of FIG. 12. This combination allows the equilibrium position of the spring 170 to be adjusted to change the force-deflection curve of the overall actuator of FIG. 12.

Although not discussed, a person of ordinary skill in the art will recognize that, in practice, conventional mechanical connectors and fittings are to be used with the spring and the PAM of FIGS. 7-12. Such mechanical connectors and fittings are necessary for mechanical coupling to a structure and/or device and for supplying the bladder with a pneumatic source. Furthermore, control devices, such as a control valve or a servo valve, a pressure regulator, a pressure sensor, feedback loops, etc. may be necessary, where applicable, to automate the SOMs to deliver pushing and pulling forces. Other mechanical devices include clamping means, hose clamps, adjustment screws, and the like to adjust the equilibrium position of the spring.

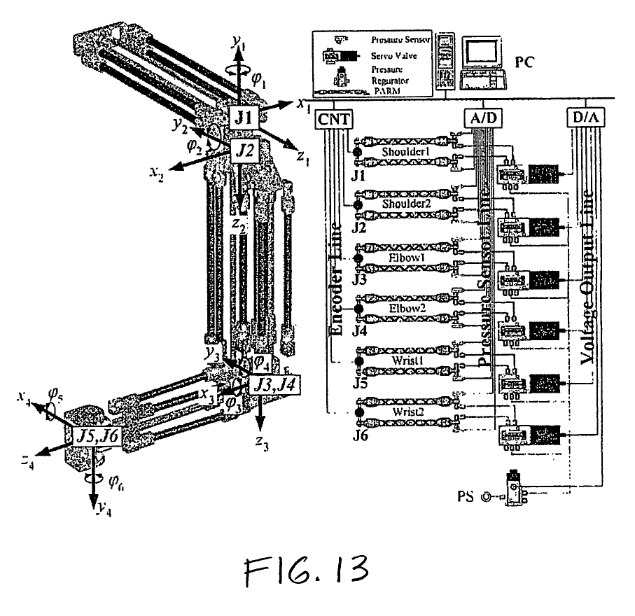

An additional exemplary application of the SOMs of the present invention is in robotics. FIG. 13 is a reproduced image of a six-degree of freedom pneumatic robot arm published in an article entitled “Developing a Robot Arm using Pneumatic Artificial Rubber Muscles” by Nakamura et al., which is available for viewing at the following website: http://www.k-k.pi.titech.ac.jp/pam/PTMC2002Final.pdf. The contents of the Nakamura et al. article are expressly incorporated herein by reference. As explained in the Nakamura et al. article and as shown in the FIG. 13 drawing, twelve individual pneumatic muscles are used to create a robotic arm having six degree of freedom. Each joint (shown as J1 to J6) is moved by a pair of prior pneumatic muscle. However, if the spring over muscle embodiments of the present invention are used, the number of pneumatic muscles may be reduced to six to still achieve the desired six degree of freedom.

Although the preferred embodiments of the invention have been described with some specificity, the description and drawings set forth herein are not intended to be delimiting, and persons of ordinary skill in the art will understand that various modifications may be made to the embodiments discussed herein without departing from the scope of the invention, and all such changes and modifications are intended to be encompassed within the appended claims. Various changes to the SOMs described elsewhere herein including changes in the manner in which the equilibrium position of the spring may be adjusted, the attachments ends for cooperating or accepting different fasteners, hooks, etc., and using different sized pneumatic muscles and spring with different spring constant to obtain a desired force-deflection curve. Other changes include using the SOMs in different applications, such as in manufacturing, simulator technology, equipment, amusement, process plants, metal/wood working, construction, medical/biomedical, and aerospace, just to name a few. Accordingly, many alterations and modifications may be made by those having ordinary skill in the art without deviating from the spirit and scope of the invention.

What is claimed is:

1. A muscle actuator comprising an inner bladder comprising a first end and a second end and the inner bladder being configured to communicate with a pneumatic source, a braided material wrapped over at least a substantial portion of the inner bladder, an end fitting attached to both the first end and the second end, and a helical coil spring positioned over at least a portion of the braided material or inside the inner bladder.

2. The muscle actuator of claim 1, further comprising a control mechanism for controlling the amount of flow of the pneumatic source into and out of the inner bladder.

3. The muscle actuator of claim 1, wherein the helical coil spring is positioned over at least a portion of the braided material.

4. The muscle actuator of claim 3, wherein the helical coil spring comprises two ends, and wherein one of the two ends is mechanically coupled to a clamping device.

5. The muscle actuator of claim 4, further comprising an elongated shell positioned over at least a portion of the braided material and wherein the clamping device is clamped to the elongated shell.

6. The muscle actuator of claim 5, wherein the elongated shell comprises two individual shell members in telescoping relationship with one another.

7. The muscle actuator of claim 6, further comprising a second clamping device mechanically coupled to the second end of the helical coil spring.

8. The muscle actuator of claim 1, wherein the helical coil spring is positioned over at least a portion of the braided material, and wherein an elongated shell is positioned over the helical coil spring.

9. The muscle actuator of claim 8, wherein the spring comprises two ends, and wherein a disc comprising an opening is mechanically coupled to one of the ends.

10. A muscle actuator comprising an inner bladder comprising a first end and a second end and the inner bladder being configured to communicate with a pneumatic source, a braided material wrapped over at least a substantial portion of the inner bladder, an end fitting attached to both the first end and the second end, and a mechanical device capable of receiving a compression force and generating a pushing force when the compression force is removed mounted in parallel with the muscle actuator.

11. The muscle actuator of claim 10, wherein the mechanical device is a shock absorber.

12. The muscle actuator of claim 11, wherein the shock absorber is a compression gas spring-type shock absorber.

13. The muscle actuator of claim 11, wherein the shock absorber is a locking compression gas spring-type shock absorber.

14. The muscle actuator of claim 10, wherein the mechanical device is a helical spring.

15. The muscle actuator of claim 14, wherein the helical spring is mounted over the muscle actuator.

16. The muscle actuator of claim 14, wherein the helical spring is mounted inside the inner bladder.

17. The muscle actuator of claim 14, wherein the helical spring is mounted adjacent the muscle actuator.

18. The muscle actuator of claim 17, wherein the helical spring includes an adjustment clamp.

19. The muscle actuator of claim 10, further comprising a second muscle actuator mounted in parallel and spaced apart from one another.

20. The muscle actuator of claim 19, further comprising a knee brace, wherein one of the ends of each of the muscle actuator is mechanically coupled to the knee brace.

21. The muscle actuator of claim 14, wherein the helical spring comprises two clamping devices.

22. The muscle actuator of claim 21, wherein the two clamping devices are clamped to a telescoping structure.

23. The muscle actuator of claim 22, wherein telescoping structure comprises a starting position, and wherein the two clamping devices clamp the helical spring in a compressed positioned when the telescoping structure is in the starting position.

24. The muscle actuator of claim 22, wherein telescoping structure comprises a starting position, and wherein the two clamping devices clamp the helical spring in a stretched position when in the starting position.

25. The muscle actuator of claim 10, further comprising a second muscle actuator comprising a second mechanical device mounted in parallel with the muscle actuator, wherein the muscle actuator and the second muscle actuator are positioned on two different sides of a pivoting member.

26. The muscle actuator of claim 25, wherein the pivoting member is a pivot joint.

27. The muscle actuator of claim 10, further comprising a second muscle actuator comprising a second mechanical device mounted in parallel with the muscle actuator, wherein the muscle actuator and the second muscle actuator are both coupled to a knee brace.

28. The muscle actuator of claim 10, wherein the two end fittings of the muscle actuator are attached to a structure comprising a pivot arm; and wherein the mechanical device is also attached to the same structure with the pivot arm.

29. The muscle actuator of claim 10, further comprising a second mechanical device mounted in parallel with the muscle actuator.

30. The muscle actuator of claim 29, wherein the muscle actuator and the two mechanical devices are mounted to two flanges.

31. The muscle actuator of claim 10, further comprising a second muscle actuator, a third muscle actuator, and a fourth muscle actuator, each of the second through fourth actuator comprising a mechanical device mounted in parallel with the muscle actuator, wherein the muscle actuator and the second muscle actuator are positioned on two different sides of a first pivoting member, and wherein the third muscle actuator and the fourth muscle actuator are positioned on two different sides of a second pivoting member.

32. The muscle actuator of claim 31, wherein the first pivoting member and the second pivoting member are pivot joints.

33. A combination pneumatic actuator muscle and a mechanical device capable of receiving a compression force and generating a pushing force when the compression force is removed mounted to a first surface and a second surface,
wherein a passage is incorporated in a header of the pneumatic actuator muscle for receiving a pressurized source,
wherein the pneumatic actuator muscle produces a pulling force to compress the mechanical device when the pressurized source enters the pneumatic actuator muscle; and
wherein the mechanical device generates a pushing force when the pressurized source is discharged from the pneumatic actuator muscle.

34. The combination pneumatic actuator muscle and mechanical device of claim 33, wherein the mechanical device is a shock absorber.

35. The combination pneumatic actuator muscle and mechanical device of claim 34, wherein the shock absorber is a locking compression gas spring-type shock absorber.

36. The combination pneumatic actuator muscle and mechanical device of claim 33, wherein the mechanical device is a helical spring.
